(19) United States
(12) Patent Application Publication
(10) Pub. No.: US 2019/0331260 A1
(43) Pub. Date: Oct. 31, 2019

(54) Cable Trough System

(71) Applicant: Telect, Inc., Liberty Lake, WA (US)

(72) Inventors: Bryan Joseph Kioski, Spokane, WA (US); Steven W. Ellison, Mead, WA (US)

(21) Appl. No.: 15/962,689

(22) Filed: Apr. 25, 2018

(51) Int. Cl. F16L 3/26; F16B 5/00; H02G 3/04; F21V 33/00; H02G 3/00; F21S 8/04

(52) U.S. Cl. CPC F16L 3/26; F16B 5/0016; H02G 3/0437; F21Y 2115/10; F21V 33/006; H02G 3/26; F21S 8/046; H02G 3/0406

(57) ABSTRACT

A trough system for routing connectivity cables. A first member extending a longitudinal length and having a carrying surface in an x-y dimensional plane and forming a first portion of the trough system. A second member extending a longitudinal length and having a carrying surface in the x-y dimensional plane and forming a second portion of the trough system. The second member configured to attach coplanarly to a first side of the first member. A third member extending a longitudinal length and having a carrying surface in the x-y dimensional plane and for forming a third portion of the trough system. The third member configured to attach coplanarly to a second side, opposite the first side, of the first member.

### BACKGROUND

Optical fibers can be used to transmit large volumes of data and voice signals over relatively long distances, with little or no signal degradation. For this reason, optical fibers have become widely used in the telecommunication field. As the use of optical fibers has increased, new systems have been developed for managing and organizing larger numbers of optical fibers.

In a typical telecommunications facility, a trough system is used to route the fiber optic cables. Generally, the trough system is located overhead and over the location of the fiber optic racks, cabinets, and other equipment. The trough system in even a small telecommunications facility can be substantial, requiring significant time and expense to install. Some systems require tools for installation of the trough system, adding to the assembly time and expense. Even systems that do not require tools for installation of the system may require substantial planning to design the trough coupling system for a particular installation.

Making larger trough systems to accommodate the large numbers of optical fibers from a single molded part can be difficult. For example, making longitudinal trough members having a width of about 24 inches across or more can be difficult to mold in a single part with an extrusion.

### BRIEF SUMMARY

This Brief Summary is provided to introduce simplified concepts relating to trough systems for routing connectivity cables (e.g., optical fibers) which are further described below in the Detailed Description. This summary is not intended to identify essential features of the claimed subject matter, nor is it intended for use in determining the scope of the claimed subject matter.

This disclosure relates to trough systems for routing connectivity cables that can be extrusion molded and assembled and disassembled quickly and easily. Generally, the trough systems include members extending a longitudinal length and configured to attach coplanarly. The members have sides arranged to attach to each other coplanarly along the longitudinal length. The members may be coplanarly attached along the longitudinal length via a snap-fit, interference-fit, friction-fit, press-fit, etc. on site. The members are attached together to form the trough systems. An advantage of such trough systems is that the trough systems provide improved manufacturability and improved ease of installation. For example, one advantage of attaching individual members coplanarly along the longitudinal length to form the trough systems is that it provides for molding smaller individual members that quickly assemble into a large unit more easily than molding a single extrusion as a large unit. For example, the individually molded members may be attached coplanarly along the longitudinal length to form a longitudinal trough system having a width of about 24 inches across or more, which is relatively more easy than extrusion molding a single longitudinal trough having a width of about 24 inches across or more.

Furthermore, as trough systems are intended for carrying significant lengths of cable, the length of a section of a trough system is generally relatively much longer than the width thereof. For example, a section of a trough system may extend 12 feet or longer, while the individual pieces that are assembled to form the section may be less than 12 inches in width. Moreover, each section of the trough system may be less than one inch thick. In an effort to minimize cost and increase the speed of production, conventional trough systems are frequently formed using a lightweight plastic material. While plastic may be cheaper to manufacture, easier to use, and faster to produce the pieces, due to the material properties associated with plastic, a piece of a trough system (or any plastic object) having dimensions similar to those described above (e.g., ˜12′ long x˜12″ wide x˜1″ thick) has a natural tendency to flex along the length thereof when not supported at regular intervals. In a known conventional trough system having multiple pieces, due to the design of the connection means implemented therein, the assembly of two adjacent trough pieces is known to require at least two positioning steps to create a stable connection. A first step requires orienting a lateral side (i.e., in the length direction) of one trough piece with respect to an adjacent lateral side of another trough piece such that the respective x-y planes of the trough pieces intersect at an obtuse angle, where the x direction is the width and the y direction is the length of the trough pieces. This first orientation enables the opposing connection means to engage within preshaped entry locations on the lateral sides. The second step is to then allow the trough pieces to relax and lay coplanarly. However, because the trough pieces are plastic and are so long, the first step requires either multiple workers or an additional tool/instrument to support and hold the entire length of one of the trough pieces in the correct orientation to enable the connection means to engage properly before the trough piece is able to be relaxed. Thus, the conventional trough system is complicated to assemble.

In an embodiment of the instant application, a trough system for routing connectivity cables includes a first member, a second member, and a third member. The first member may be in a plane and extend a longitudinal length for forming a first portion of a carrying surface of the trough system. The second member may be in the same plane and extend the longitudinal length for forming a second portion of the carrying surface of the trough system. Thus, the second member is configured to attach coplanarly to a first side of the first member. The third member may also be in the same plane and extend the longitudinal length for forming a third portion of the carrying surface of the trough system. Therefore, the third member is configured to attach coplanarly to a second side, opposite the first side, of the first member.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 illustrates an example trough system for routing connectivity cables in a telecommunication facility.

FIG. 2 illustrates a top perspective view of a section of the trough systems illustrated in FIG. 1.

FIG. 3 illustrates a bottom perspective view of the section of the trough systems illustrated in FIG. 2.

FIG. 4 illustrates an exploded assembly view of the section illustrated in FIG. 2.

FIG. 5 illustrates a detail view of an attachment of the first member and the second member of the trough system illustrated in FIG. 1.

FIG. 6 illustrates a side view of a section of the second member illustrated in FIG. 1.

FIG. 7 illustrates a side view of a cable management component disposed with the trough system illustrated in FIG. 1.

FIG. 8 illustrates an example process of installing a trough system.

FIG. 9 illustrates a top perspective view of a coupler for coupling the trough systems illustrated in FIG. 1 to another trough system.

### DETAILED DESCRIPTION

### Overview

As noted above, making larger trough systems, to accommodate the large numbers of optical fibers, from a single molded part can be difficult, which may be particularly true for extruding a single molded trough, where the single molded trough has a width of about 24 inches across or more. This disclosure is directed to trough systems for routing connectivity cables that can be extrusion molded, and assembled and disassembled quickly and easily. The trough systems may include a plurality of members extending a longitudinal length and configured to attach coplanarly. For example, the trough systems may include a first member extending a longitudinal length and a second member extending the longitudinal length, and the first and second members may be coplanarly attached along the longitudinal length via cooperating attachment features extending at least a portion of the longitudinal length along sides of the first and second members. When coplanarly attaching the first member to the second member, for example, a user may position the first member in a plane, position the second member in the same plane, and attach (e.g., snap-fit, interference-fit, friction-fit, press-fit, etc.), coplanarly, the first member to the second member.

In this way, the trough systems for routing connectivity cables are quickly and easily assembled on site. Moreover, and in this way, the individual members may be attached coplanarly along the longitudinal length to form the trough system having a width of about 24 inches across or more, which is relatively more easy than extrusion molding a single longitudinal trough having a width of about 24 inches across or more.

While this application describes implementations that are described in the context of an overhead trough system for managing optical fibers in a telecommunications facility, the implementations described herein may be used in other environments and are applicable to other contexts. For example, the trough systems may be located at any desired location, including overhead, below the floor, or at any location in between. In addition, the trough systems may be used to manage fibers other than optical fibers, such as wires, Ethernet cables, coaxial cables, and/or other signal carrying fibers, and may be used in any environment in which such fibers are used. Moreover, while this application describes trough systems that include individual members that attach along a longitudinal length to form a longitudinal trough system having a width of about 24 inches across, other widths are contemplated. For example, the trough systems may include individual members that attach along a longitudinal length to form a longitudinal trough system having a width of about 36 inches across or more.

The trough systems may include a first member in a plane and extend a longitudinal length for forming a first portion of a carrying surface of the trough system. A second member may be in the same plane and extends the longitudinal length. The second member may provide for forming a second portion of the carrying surface of the trough system, and the second member may be configured to attach coplanarly to a first side of the first member. A third member may be in the same plane and extends the longitudinal length. The third member may provide for forming a third portion of the carrying surface of the trough system, and the third member may be configured to attach coplanarly to a second side, opposite the first side, of the first member.

The trough systems may include a first member including a first attachment feature and a second attachment feature, a second member including an attachment feature, and a third member including an attachment feature. The first and second attachment features of the first member may extend at least a portion of the longitudinal length of the first member. The attachment feature of the second member may extend at least a portion of the longitudinal length of the second member, and the attachment feature of the third member may extend at least a portion of the longitudinal length of the third member. The first attachment feature of the first member may attach coplanarly to the attachment feature of the second member or attach coplanarly to the attachment feature of the third member. The second attachment feature of the first member may attach coplanarly to the attachment feature of the second member or attach coplanarly to the attachment feature of the third member.

### Illustrative Trough Systems

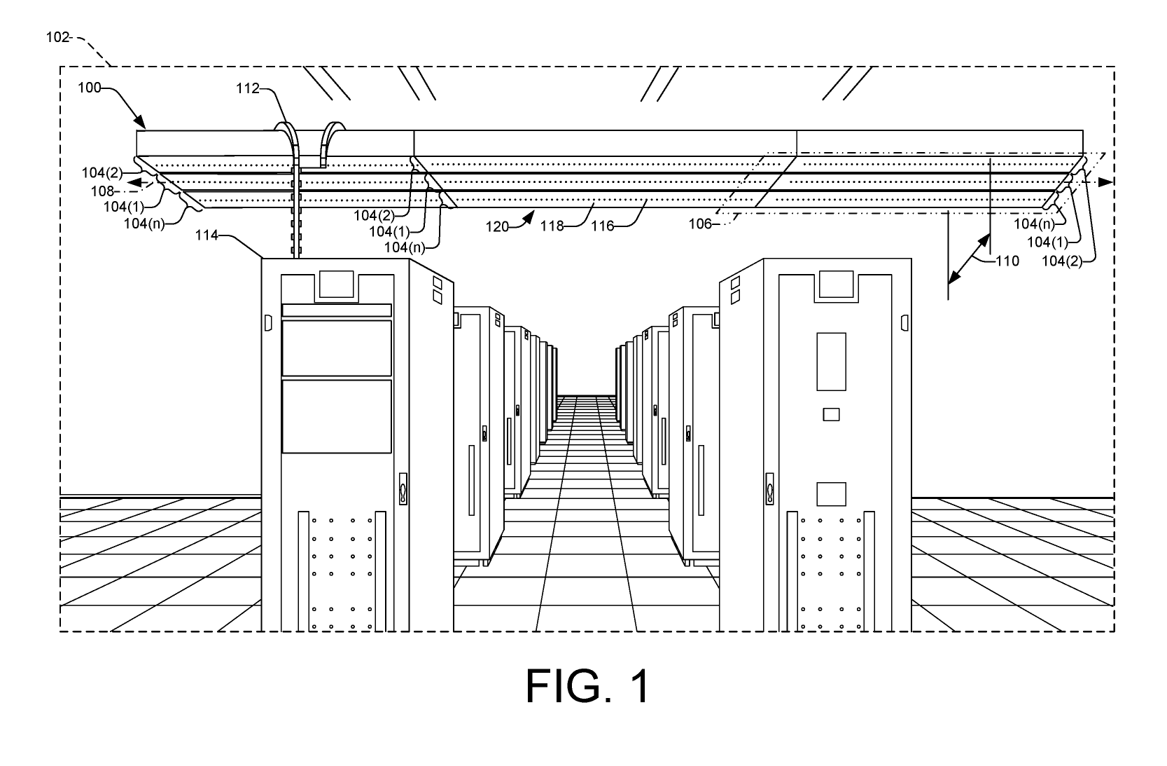

FIG. 1 illustrates an example trough system 100 for routing connectivity cables in a telecommunication facility 102. A user (e.g., a technician) may install the trough system 100 in the telecommunication facility 102 for managing and organizing large numbers of connectivity cables (e.g., optical fibers) in the telecommunication facility 102. For example, a user may attach individual members 104(1), 104(2), 104(n) in the same plane 106 (i.e., coplanarly) along a longitudinal length 108 to form the trough system 100 having a width 110 of about 24 inches across or more, to manage and organize the large numbers of connectivity cables in the telecommunication facility 102. While FIG. 1 illustrates the individual members 104(1)-104(n) having a length of about 6 feet along the longitudinal length 108, the individual members 104(1)-104(n) may have longer or shorter lengths than 12 feet. While FIG. 1 illustrates the trough system 100 including three individual members 104(1)-104(n), the trough system 100 may have less than 3 individual members or more than 3 individual members. While the individual members 104(1)-104(n) may be formed via extrusion, the individual members 104(1)-104(n) may be formed via other manufacturing methods. For example, the individual members 104(1)-104(n) may be formed via additive manufacturing, such as 3D printing. Further, while the individual members 104(1)-104(n) may be formed of plastic, the individual members 104(1)-104(n) may be formed of other materials. For example, the individual members 104(1)-104(n) may be formed of metal, composite, fabric, wood, etc.

FIG. 1 illustrates the trough system 100 may include a cable management component 112. For example, the trough system 100 may include a cable management component 112 having a passageway, and at least a portion of the passageway of the cable management component is disposed in the trough system proximate to a top of the trough system. The cable management component 112 may be a ramp for managing and organizing at least a portion of the large number of connectivity cables contained in the trough system 100 out of the trough system 100 to another location, to another piece of equipment 114, to another trough system, etc. in the telecommunication facility 102.

While FIG. 1 illustrates the cable management component 112 may be a ramp, the cable management component 112 may be another cable management component. For example, the cable management component 112 may comprise a reducer, a trumpet attachment, a T-junction, an off-ramp, a center drop, an elbow, an L-junction, an upsweep, a downsweep, etc. The trough system 100 may implement any of the cable management components, and any multiple of each of the plurality of cable management components, to provide a trough system that corresponds with the equipment configuration in a telecommunication facility in which the trough system is to be installed.

FIG. 1 illustrates the trough system 100 may include a plurality of lights 116 disposed on an underside 118 of a carrying surface 120 of the trough system 100. For example, the plurality of lights 116 may be disposed in one or more channels extending at least a portion of the longitudinal length 108 along the underside 118 of the carrying surface 120 of the trough system 100 (discussed in more detail below). The plurality of lights 116 may supplement or replace other lighting in the telecommunication facility 102. The plurality of lights 116 may comprise an integrated light source such as a plurality of high-efficiency light emitting diodes (LEDs).

While FIG. 1 illustrates the trough system 100 installed in the telecommunication facility 102, the trough system 100 may be installed in a computing facility, a central office, a data center, a server room, a remote cell site, etc.

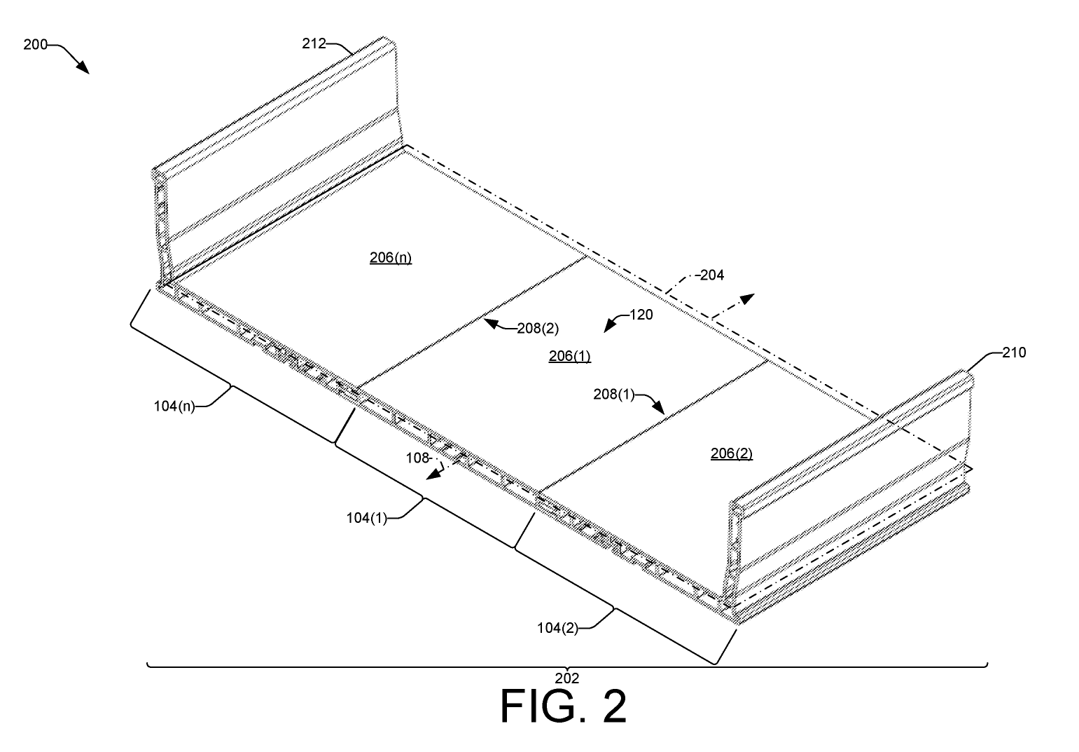

FIG. 2 illustrates a top perspective view 200 of a section 202 of the trough system 100 illustrated in FIG. 1. FIG. 2 illustrates the first member 104(1) may be in a plane 204 and extend the longitudinal length 108, the second member 104(2) may be in the same plane 204 and extend the longitudinal length 108, and the n^{th} member 104(n) may be in the same plane 204 and extend the longitudinal length 108 (e.g., the plane 204 being an x-y dimensional plane). The first member 104(1) forming a first portion 206(1) of the carrying surface 120 of the trough system 100, the second member 104(2) forming a second portion 206(2) of the carrying surface 120 of the trough system 100, and the n^{th} member 104(n) forming an n^{th} portion 206(n) of the carrying surface 120 of the trough system 100.

FIG. 2 illustrates the second member 104(2) configured to attach coplanarly to a first side 208(1) of the first member 104(1). For example, the second member 104(2) may a snap-fit, interference-fit, friction-fit, press-fit, etc. to the first side 208(1) of the first member 104(1) while the second member 104(2) positioned in the same plane 204 remains coplanar to the first member 104(1) positioned in the same plane 204. Thus, simplifying the assembly process by minimizing steps and difficulty of assembly compared to the conventional system.

FIG. 2 illustrates the n^{th} member 104(n) configured to attach coplanarly to a second side 208(2), opposite the first side 208(1), of the first member 104(1). For example, the n^{th} member 104(n) may a snap-fit, interference-fit, friction-fit, press-fit, etc. to the second side 208(2) of the first member 104(1) while the n^{th} member 104(n) positioned in the same plane 204 remains coplanar to the first member 104(1) positioned in the same plane 204.

FIG. 2 illustrates the second member includes a side wall 210 extending at least a portion of the longitudinal length 108, and the third member includes a side wall 212 extending at least a portion of the longitudinal length 108. FIG. 2 illustrates when the first, second, and n^{th} members 104(1), 104(2), and 104(n) are attached, the first, second and n^{th} members 104(1), 104(2), and 104(n) have a substantially U-shaped cross-section extending at least a portion of the longitudinal length 108. The side walls 210 and 212 providing for containing connectivity cables being routed through the trough system 100.

When the first, second, and n^{th} members 104(1), 104(2), and 104(n) are attached, the seam, joint, interface, etc. between the first member 104(1) and the second member 104(2), and the seam, joint, interface, etc. between the first member 104(1) and the n^{th} member 104(n) are each relatively small to avoid pinching any portion of any of the connectivity cables being routed through the trough system 100. For example, the each of the seam between the first member 104(1) and the second member 104(2) and the seam between the first member 104(1) and the n^{th} member 104(n) have a gap smaller than a diameter of a single optical fiber to prevent any one of the optical fibers being routed through the trough system 100 from dropping into the gaps of the seams. In one example, a single optical fiber may have an outside diameter of about 0.04 inches and each of the seams may have a gap having size smaller than the outside diameter of about 0.04 inches to prevent any of the optical fiber from dropping into the gaps and being pinched by the seams. The relatively small seams provide for the carrying surface 120 of the trough system 100 to be relatively smooth and planar.

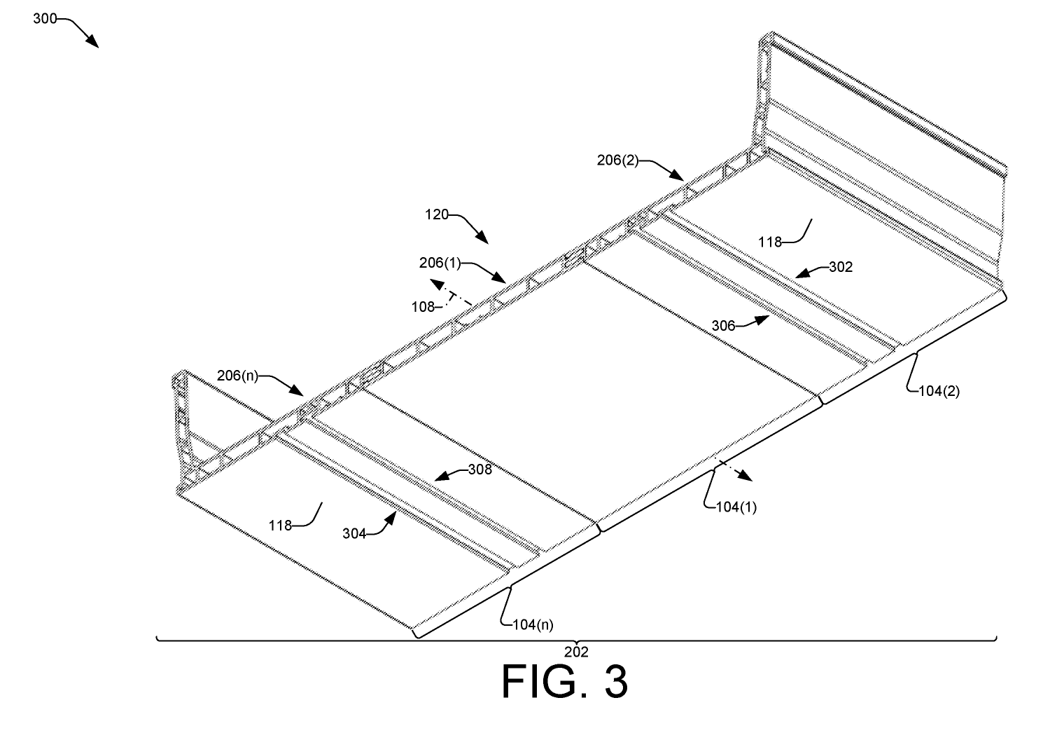

FIG. 3 illustrates a bottom perspective view 300 of the section 202 of the trough system 100 illustrated in FIG. 2. FIG. 3 illustrates a channel 302 may extend at least a portion of the longitudinal length 108 along the underside 118 of the second portion 206(2) of the carrying surface 120 of the second member 104(2). A plurality of lights (not shown) may be disposed at least partially in the channel 302. FIG. 3 illustrates a channel 304 may extend at least a portion of the longitudinal length 108 along the underside 118 of the n^{th} portion 206(n) of the carrying surface 120 of the n^{th} member 104(n). A plurality of lights (not shown) may be disposed at least partially in the channel 304. While FIG. 3 illustrates the first member 104(1) not having a channel, the first member 104(1) may include a channel. For example, a channel may extend at least a portion of the longitudinal length 108 along the underside 118 of the first portion 206(1) of the carrying surface 120 of the first member 104(1), and a plurality of lights may be disposed at least partially in the channel.

In one example, the channels 302 and 304 may be recessed into the portions of the carrying surface of the second and n^{th} members 104(2) and 104(n) and the plurality of lights may be disposed at least partially in the recessed channels 302 and 304. In another example, each of the channels 302 and 304 may be defined by a pair of flanges protruding from the portions of the carrying surface of the second and n^{th} members 104(1) and 104(n).

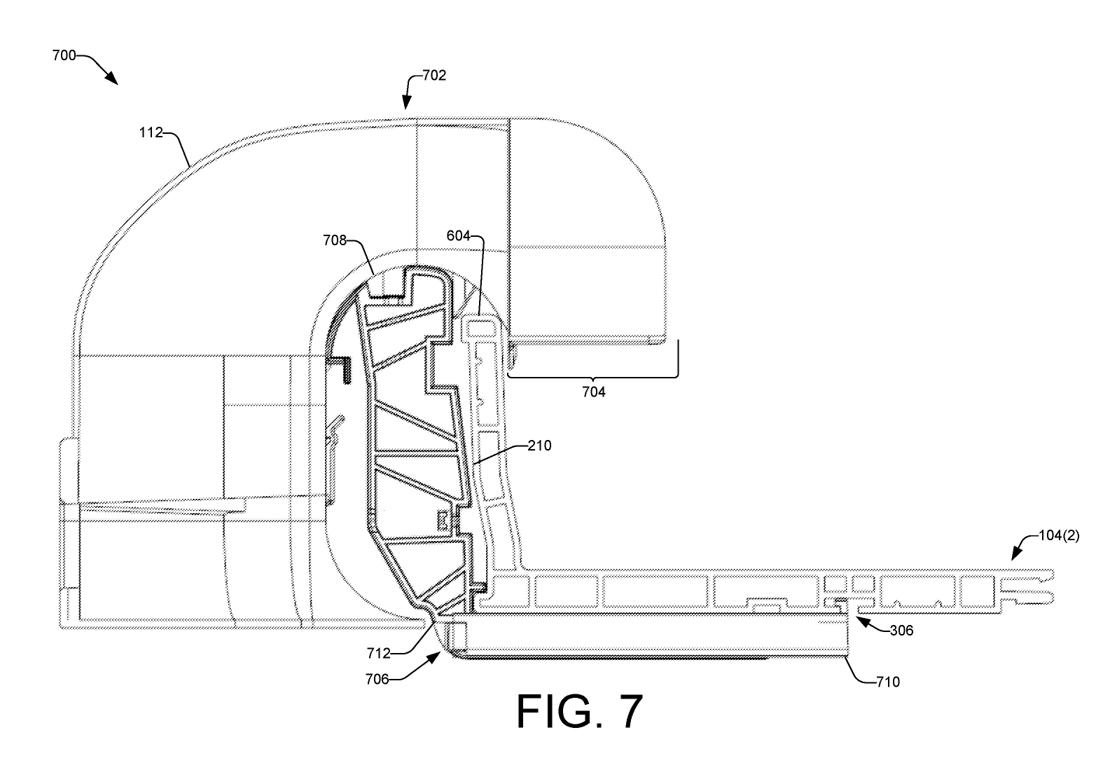

FIG. 3 illustrates a channel 306 may extend at least a portion of the longitudinal length 108 along the underside 118 of the second portion 206(2) of the carrying surface 120 of the second member 104(2). The channel 306 may provide for a support member (not shown) to be attached to the at least one channel 306 (discussed in more detail below with regard to FIG. 7). FIG. 3 illustrates a channel 308 may extend at least a portion of the longitudinal length 108 along the underside 118 of the n^{th} portion 206(n) of the carrying surface 120 of the n^{th} member 104(n). The channel 308 may provide for a support member (not shown) to be attached to the channel 308 (discussed in more detail below with regard to FIG. 7).

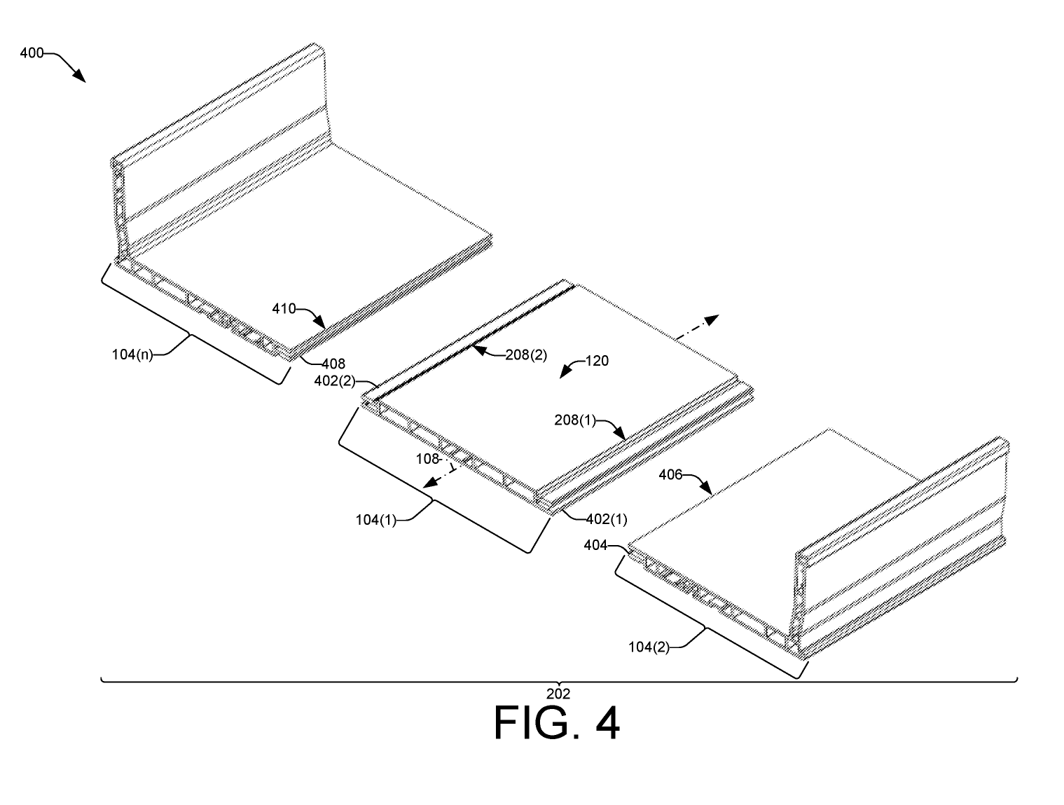

FIG. 4 illustrates an exploded assembly view 400 of the section 202 of the trough system 100 illustrated in FIG. 1. FIG. 4 illustrates the first member 104(1) may include a first attachment feature 402(1) extending at least a portion of the longitudinal length and along the first side 208(1) of the first member 104(1). FIG. 4 illustrates the first member 104(1) may include a second attachment feature 402(2) extending at least a portion of the longitudinal length 108 and along the second side 208(2), opposite the first side 208(1), of the first member 104(1).

FIG. 4 illustrates the second member 104(2) may include an attachment feature 404 extending at least a portion of the longitudinal length 108 and along a side 406 of the second member 104(2). FIG. 3 illustrates the n^{th} member 104(n) may include an attachment feature 408 extending at least a portion of the longitudinal length 108 and along a side 410 of the n^{th} member 104(n).

The first, second, third and fourth attachment features 402(1)-402(4) may provide for attaching the second member 104(2) and the n^{th} member 104(n) to the first and second sides 208(1) and 208(2) of the first member 104(1) coplanarly (as discussed above with respect to FIG. 2). For example, the first attachment feature 402(1) of the first member 104(1) may be configured to attach coplanarly to the attachment feature 404 of the second member 104(2), and the second attachment feature 402(2) of the first member 104(1) may be configured to attach coplanarly to the attachment feature 408 of the n^{th} member 104(n) for forming the carrying surface 120 of the trough system 100. In another example, the first attachment feature 402(1) of the first member 104(1) may be configured to attach coplanarly to the attachment feature 408 of the n^{th} member 104(n), and the second attachment feature 402(2) of the first member 104(1) may be configured to attach coplanarly to the attachment feature 404 of the second member 104(2) for forming the carrying surface 120 of the trough system 100.

The attachment features 402(1), 402(2), 404, and 406 may be snap-fit features, interference-fit features, friction-fit features, press-fit features, etc. configured to attach the first member 104(1), the second member 104(2), and the n^{th} member 104(n) while the first member 104(1), the second member 104(2), and the n^{th} member 104(n) remain coplanar. For example, the first member 104(1), the second member 104(2), and the n^{th} member 104(n) may be pushed together, while in the same plane 204, to snap-fit, interference-fit, friction-fit, press-fit, the first member 104(1), the second member 104(2), and the n^{th} member 104(n) in the same plane 204.

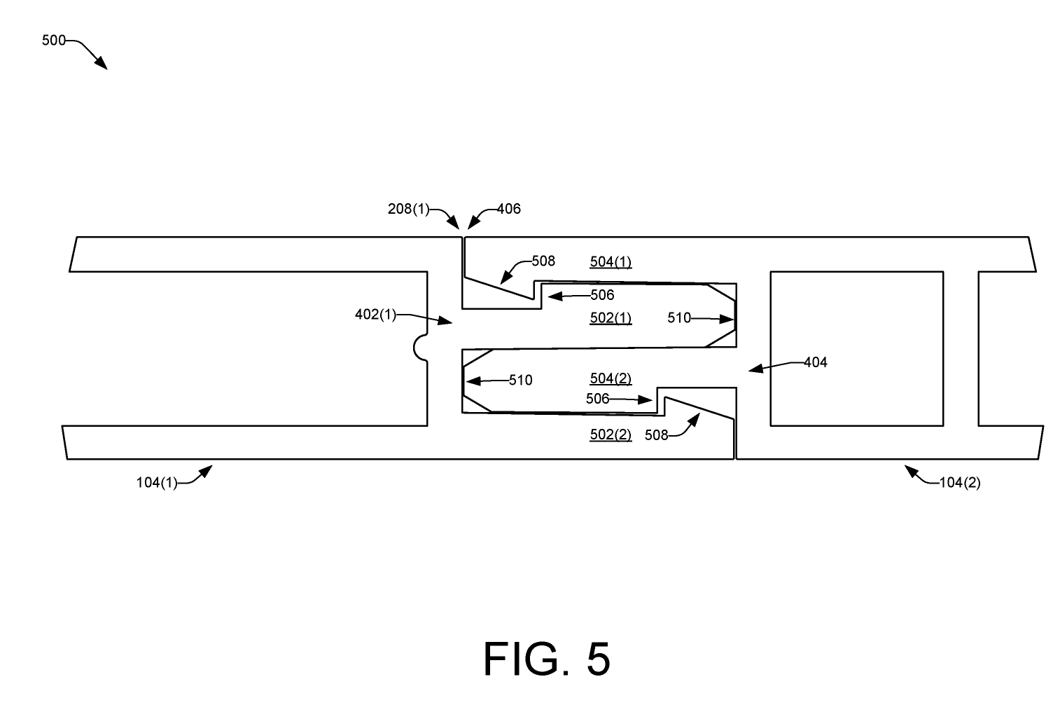

FIG. 5 illustrates a detail view 500 of the attachment of the first attachment feature 402(1) of the first member 104(1) and the attachment feature 404 of the second member 104(2). FIG. 5 illustrates the first attachment feature 402(1) of the first member 104(1) may include snap-fit members 502(1) and 502(2), and the attachment feature 404 of the second member 104(2) may include cooperating snap-fit members 504(1) and 504(2). Snap-fit members 502(1) and 504(2) may include a lip 506. Snap-fit members 502(2) and 504(1) may include hook edges 508. The hook edges 508 of the snap-fit members 502(2) and 504(1) may engage with the lips 506 of the snap-fit members 502(1) and 504(2) to attach the first member 104(1) to the second member 104(2). Snap-fit members 502(1) and 504(2) may each include a narrow entry edge 510. The narrow entry edge 510 of snap-fit member 502(1) may provide for snap-fit member 502(1) to pass between snap-fit members 504(1) and 504(2), and the narrow entry edge 510 of snap-fit member 504(2) may provide for snap-fit member 504(2) to pass between snap-fit members 502(1) and 502(2). FIG. 5 illustrates the snap-fit member 502(1) cooperating with the snap-fit member 504(1), and the snap-fit member 502(2) cooperating with the snap-fit member 504(2). When the attachment feature 402(1) of the first member 104(1) and the attachment feature 404 of the second member 104(2) are pushed together to be coplanarly attached, the snap-fit member 504(1) may deflect out of a resting position to experience a momentary displacement over the snap-fit member 502(1) to be engaged. Similarly, when the attachment feature 402(1) of the first member 104(1) and the attachment feature 404 of the second member 104(2) are coplanarly attached, the snap-fit member 502(2) may deflect out of a resting position to experience a momentary displacement over the snap-member 504(2) to be engaged.

The attachment of the second attachment feature 402(2) of the first member 104(1) with the attachment feature 408 of the n^{th} member 104(n) may be the same as the attachment of the first attachment feature 402(1) of the first member 104(1) and the attachment feature 404 of the second member 104(2). For example, the second attachment feature 402(2) of the first member 104(1) may include snap-fit members, and the attachment feature 408 of the n^{th} member 104(n) may include cooperating snap-fit members that coplanarly attach.

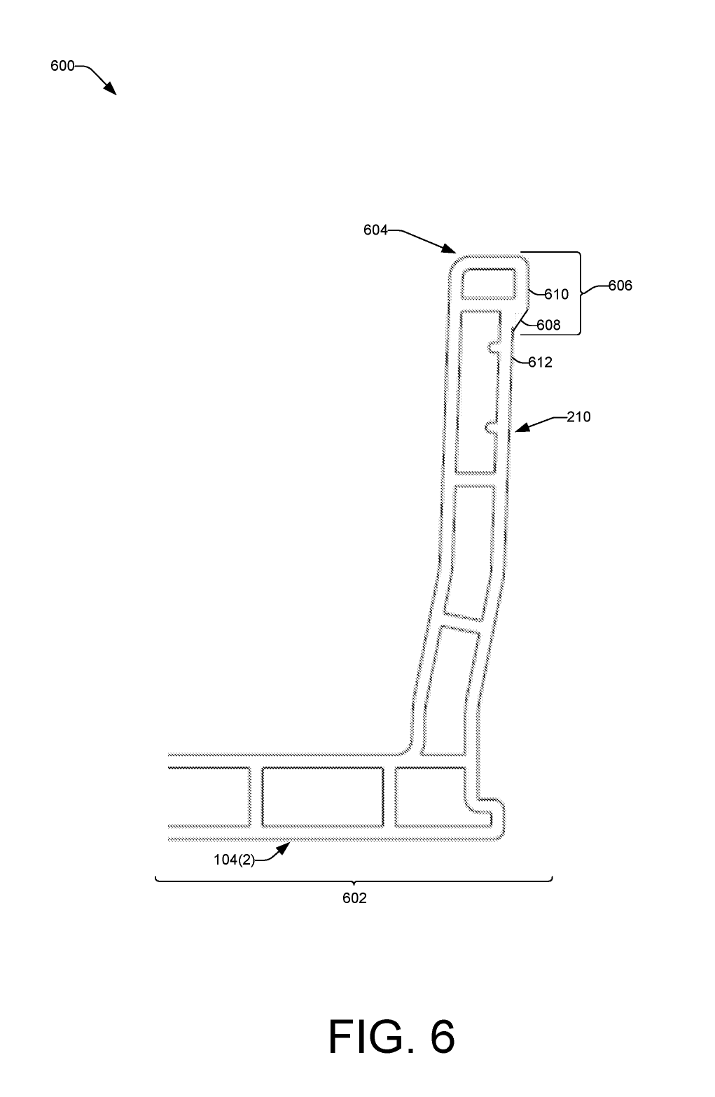

FIG. 6 illustrates a side view 600 of a section 602 of the second member 104(2) illustrated in FIG. 1. FIG. 6 illustrates a top portion 604 of the side wall 210 of the second member 104(2) may include a lip 606. The lip 606 may include a beveled portion 608 extending from a surface 610 of the lip 606 to a surface 612 of the side wall 210. The portion 608 extending from the surface 610 of the lip 606 to the surface 612 of the side wall 210 may simplify an additive manufacturing process for the trough system 100. For example, the portion 608 extending from the surface 610 of the lip 606 to the surface 612 of the side wall 210 may provide for supporting the overhang of the lip 606 while additively manufacturing the lip 606 of the side wall 210.

FIG. 7 illustrates a side view 700 of the cable management component 112 having a passageway 702, and at least a portion 704 of the passageway 702 of the cable management component 112 is disposed in the trough system 100 proximate to the top 604 of the trough system 100. FIG. 7 illustrates a support member 706 attached to the channel 302 of the second member 104(2) and attached to an underside 708 of the cable management component 112. The support member 706 may include a first member 710 slidably engaged with a second member 712. The first member 710 of support member 706 may be engaged with the channel 302 and the second member 712 of the support member may slidably adjust up adjacent to the side wall 210 of the second member 104(2) to attach the support member 706 to the second member 104(2). Subsequent to attaching the support member 706 to the second member 104(2), the cable management component 112 may be attached to the support member 706 such that the portion 704 of the passageway 702 of the cable management component 112 is disposed in the trough system 100 proximate to the top 604 of the trough system 100.

### Illustrative Methods of Installing Trough Systems

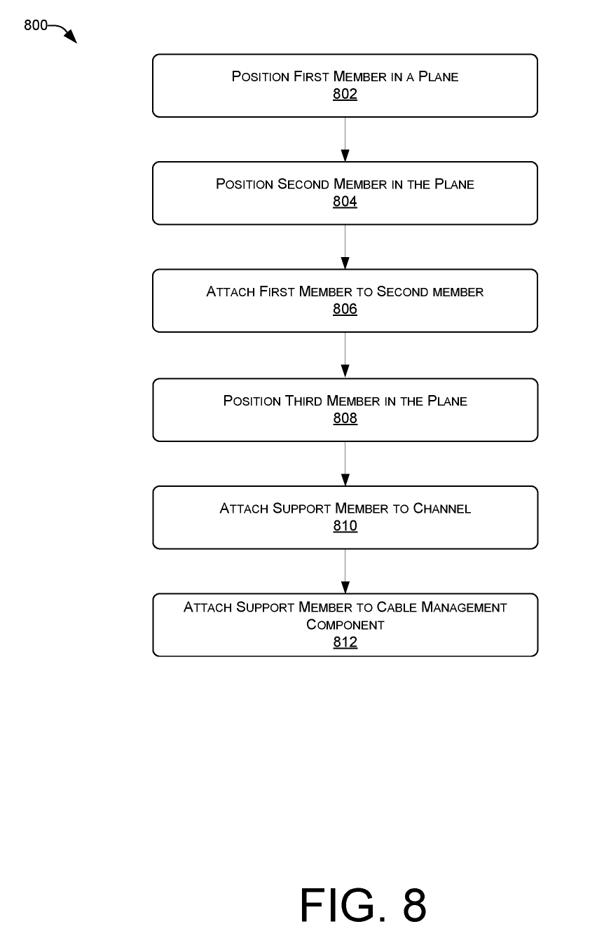

FIG. 8 illustrates an example process 800 of installing a trough system (e.g., trough system 100) for routing connectivity cables in a telecommunication facility (e.g., telecommunication facility 102). By way of example and not limitation, this process may be performed on site in the telecommunication facility.

Process 800 includes operation 802, which represents positioning a cable carrying surface of a first member (e.g., first member 104(1)) in a plane (e.g., plane 204). The first member extending a longitudinal length (e.g., longitudinal length 108) and forming a first portion (e.g., first portion 206(1)) of a carrying surface (e.g., carrying surface 120) of the trough system.

Process 800 continues with operation 804, which represents positioning a cable carrying surface of a second member (e.g., second member 104(2)) in the same plane. The second member extending the longitudinal length and forming a second portion (e.g., second portion 206(2)) of the carrying surface of the trough system.

Process 800 continues with operation 806, which represents attaching, coplanarly, the second member to a first side (e.g., first side 208(1)) of the first member. For example, a first attachment feature (e.g., first attachment feature 402(1)) of the first member may attach coplanarly to an attachment feature (e.g., attachment feature 404) of the second member. For example, the attachment features may be snap-fit features, interference-fit features, friction-fit features, press-fit features, etc. configured to attach the first member and the second member while the first member and the second member remain coplanar.

In one example, process 800 may continue with operation 808, which represents positioning a cable carrying surface of a third member (e.g., n^{th} member 104(n)) in the same plane. The third member extending the longitudinal length and forming a third portion (e.g., n^{th} portion 206(n)) of the carrying surface of the trough system. Operation 808 may include attaching, coplanarly, the third member to a second side (e.g., second side 208(2)) of the first member. For example, a second attachment feature (e.g., second attachment feature 402(2)) of the first member may attach coplanarly to an attachment feature (e.g., attachment feature 408) of the third member. For example, the attachment features may be snap-fit features, interference-fit features, friction-fit features, press-fit features, etc. configured to attach the first member and the third member while the first member and the third member remain coplanar.

In another example, process 800 may continue with operation 810, which represents attaching a support member (e.g., support member 706) to a channel (e.g., channel 306 or channel 308).

Process 800 may be completed with operation 812, which represents attaching the support member to an underside (e.g., underside 708) of a cable management component (e.g., cable management component 112). The cable management component having a passageway (e.g., passageway 702), and at least a portion (e.g., portion 704) of the passageway of the cable management component is disposed in the trough system proximate to a top surface (e.g., top surface 604) of the trough system.

While this application describes implementations that are described in the context of a three-part assembly (e.g., three members) that connects in a coplanar manner, there may be only a two-part assembly (e.g., two members) that connects in a coplanar manner.

### Illustrative Coupler Systems

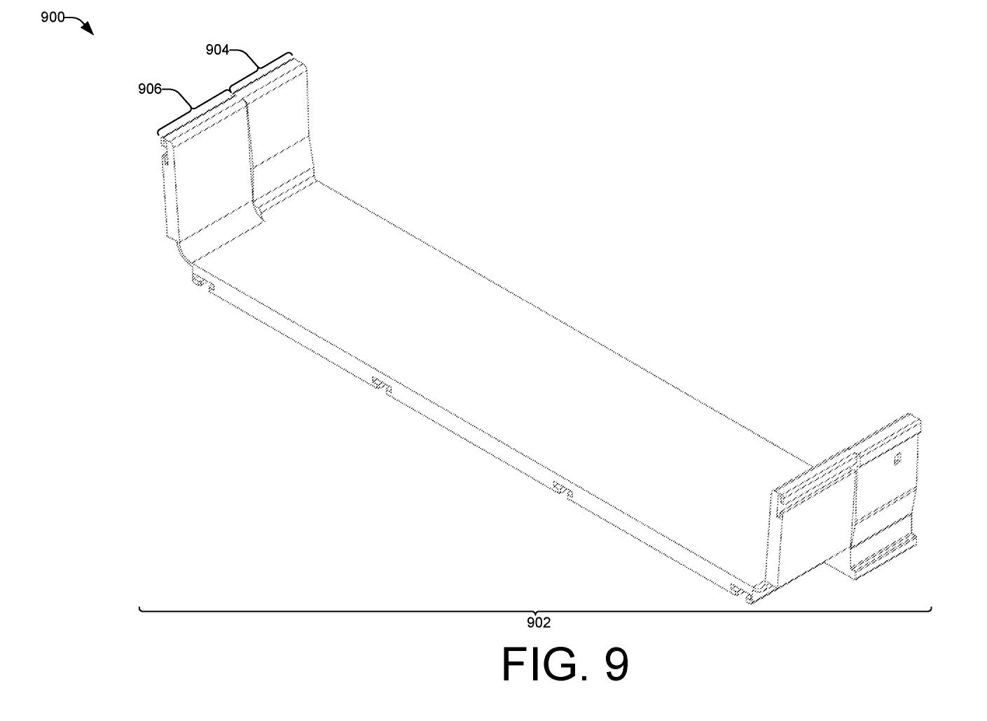

FIG. 9 illustrates a top perspective view 900 of a coupler 902 for coupling the trough system 100 illustrated in FIG. 1 to another trough system. For example, the coupler 902 may include a first portion 904 for coupling to an end of the trough system 100 and a second portion 906 for coupling to an end of another trough system different than the trough system 100. For example, the other trough system may have different features arranged in the walls of the other trough system, different sized walls, a different cross-sectional profile, etc. than the trough system 100, and the second portion 906 of the coupler 902 may be configured to couple with the other trough system having these different features arranged in the walls of the other trough system, different sized walls, a different cross-sectional profile, etc. Similarly, the first portion 904 of the coupler 902 may be configured to couple with the trough system 100 having different features arranged in the walls, different sized walls, a different cross-sectional profile, etc. than the other trough system 100.

While FIG. 9 illustrates the first portion 904 and the second portion 906 of the coupler 902 may be formed of one piece of material (e.g., plastic, metal, wood, composite, etc.), the first portion 904 may be formed of a first piece of material and the second portion 906 may be formed of a second separate piece of material. While FIG. 9 illustrates the coupler 902 may be formed via additive manufacturing, the coupler 902 may be formed via machining (e.g., computer numerical control (CNC) machined), molded, assembly, etc.

### CONCLUSION

Although the invention has been described in language specific to structural features and/or methodological acts, it is to be understood that the invention is not necessarily limited to the specific features or acts described. Rather, the specific features and acts are disclosed as illustrative forms of implementing the invention. For example, while embodiments are described having certain shapes, sizes, and configurations, these shapes, sizes, and configurations are merely illustrative.

What is claimed is:

1. A trough system for routing connectivity cables, the trough system comprising:
a first member extending a longitudinal length and having a carrying surface in an x-y dimensional plane, where a width of the carrying surface defines the x dimensional direction and a length of the carrying surface defines the y dimensional direction, the first member forming a first portion of the trough system;
a second member extending the longitudinal length and having a carrying surface in the x-y dimensional plane, the second member forming a second portion of the trough system, and the second member configured to attach coplanarly, in the x-y dimensional plane, to a first side of the first member; and
a third member extending the longitudinal length and having a carrying surface in the x-y dimensional plane, the third member forming a third portion of the trough system, and the third member configured to attach coplanarly to a second side, opposite the first side, of the first member.

2. The trough system of claim 1, wherein:
the second member includes a side wall extending at least a portion of the longitudinal length;
the third member includes a side wall extending at least a portion of the longitudinal length; and
wherein when the first, second, and third members are attached, the first, second and third members have a substantially U-shaped cross-section extending at least a portion of the longitudinal length.

3. The trough system of claim 1, wherein at least one of the first member, the second member, or the third member is formed via extrusion or additive manufacturing.

4. The trough system of claim 1, further comprising a plurality of lights disposed on an underside of the carrying surface of the trough system.

5. The trough system of claim 1, further comprising:
at least one channel extending at least a portion of the longitudinal length along an underside of the first portion of the carrying surface of the first member, along an underside of the second portion of the carrying surface of the second member, or along an underside of the third portion of the carrying surface of the third member; and
a plurality of lights disposed at least partially in the at least one channel.

6. The trough system of claim 5, wherein the at least one channel is recessed into the underside of the first portion of the carrying surface of the first member, recessed into the underside of the second portion of the carrying surface of the second member, or recessed into the underside of the third portion of the carrying surface of the third member; or
wherein the channel is defined by a pair of flanges protruding from the underside of the first portion of the carrying surface of the first member, a pair of flanges protruding from the underside of the second portion of the carrying surface of the second member, or a pair of flanges protruding from the underside of the third portion of the carrying surface of the third member.

7. The trough system of claim 1, further comprising:
at least one channel extending at least a portion of the longitudinal length along an underside of the second portion of the carrying surface of the second member, or along an underside of the third portion of the carrying surface of the third member; and
a support member attached to the at least one channel and attached to an underside of a cable management component, the cable management component having a passageway, and at least a portion of the passageway of the cable management component is disposed in the trough system proximate to a top surface of the trough system.

8. A trough system for routing connectivity cables, the trough system comprising:
a first member extending a longitudinal length and having a carrying surface in an x-y dimensional plane, where a width of the carrying surface defines the x dimensional direction and a length of the carrying surface defines the y dimensional direction, the first member including:
a first attachment feature extending at least a portion of the longitudinal length and along a first side of the first member, and
a second attachment feature extending at least a portion of the longitudinal length and along a second side, opposite the first side, of the first member;
a second member extending the longitudinal length and having a carrying surface in the x-y dimensional plane, the second member including:
an attachment feature extending at least a portion of the longitudinal length and along a side of the second member;
a third member extending the longitudinal length and having a carrying surface in the x-y dimensional plane, the third member including:
an attachment feature extending at least a portion of the longitudinal length and along a side of the third member; and
wherein the first attachment feature of the first member is configured to attach coplanarly to the attachment feature of the second member or attach coplanarly to the attachment feature of the third member for forming the carrying surface of the trough system, and the second attachment feature of the first member is configured to attach coplanarly to the attachment feature of the second member or attach coplanarly to the attachment feature of the third member for forming the carrying surface of the trough system.

9. The trough system of claim 8, wherein:
the second member includes a side wall extending at least a portion of the longitudinal length;
the third member includes a side wall extending at least a portion of the longitudinal length; and
wherein when the first, second, and third members are attached, the first, second and third members have a substantially U-shaped cross-section extending at least a portion of the longitudinal length.

10. The trough system of claim 8, wherein the first attachment feature of the first member includes a first snap-fitting member extending at least the portion of the longitudinal length and along the first side of the first member, and the second attachment feature of the first member includes a second snap-fitting member extending at least the portion of the longitudinal length and along the second side of the first member.

11. The trough system of claim 10, wherein the first snap-fitting member includes a narrow entry edge, and the second snap-fitting feature includes a hook edge.

12. The trough system of claim 8, further comprising:
at least one channel extending at least a portion of the longitudinal length along an underside of the first member, an underside of the second member, or an underside of the third member; and
a plurality of lights disposed at least partially in the at least one channel.

13. The trough system of claim 12, wherein the at least one channel is recessed into the underside of the first member, recessed into the underside of the second member, or recessed into the underside of the third member; or
wherein the channel is defined by a pair of flanges protruding from the underside of the first member, a pair of flanges protruding from the underside of the second member, or a pair of flanges protruding from the underside of the third member.

14. The trough system of claim 8, further comprising:
at least one channel extending at least a portion of the longitudinal length along an underside of the second member, or along an underside of the third member; and
a support member attached to the at least one channel and attached to an underside of a cable management component, the cable management component having a passageway, and at least a portion of the passageway of the cable management component is disposed in the trough system proximate to a top surface of the trough system.

15. A method of assembling a trough system for routing connectivity cables, the method comprising:
positioning, in a plane, a first member extending a longitudinal length and having a carrying surface in an x-y dimensional plane, where a width of the carrying surface defines the x dimensional direction and a length of the carrying surface defines the y dimensional direction, the first member forming a first portion of the trough system;
positioning, in the plane, a second member extending the longitudinal length and having a carrying surface in the x-y dimensional plane and forming a second portion of the trough system;
attaching, coplanarly, the second member to a first side of the first member.

16. The method of assembling the trough system of claim 15, further comprising:
positioning, in the plane, a third member extending the longitudinal length and having a carrying surface in the x-y dimensional plane and forming a third portion of the trough system; and
attaching, coplanarly, the third member to a second side, opposite the first side, of the first member.

17. The method of assembling the trough system of claim 16, wherein attaching, coplanarly, the third member to the second side of the first member includes snap-fitting an attachment feature extending at least a portion of the longitudinal length and along the second side of the first member to an attachment feature extending at least a portion of the longitudinal length and along a side of the third member.

18. The method of assembling the trough system of claim 15, further comprising:
attaching a support member to a channel, the channel extending at least a portion of the longitudinal length along an underside of the second member.

19. The method of assembling the trough system of claim 18, further comprising:
attaching the support member to an underside of a cable management component, the cable management component having a passageway, and at least a portion of the passageway of the cable management component is disposed in the trough system proximate to a top surface of the trough system.

20. The method of assembling the trough system of claim 15, wherein attaching, coplanarly, the first side of the first member to the second member includes snap-fitting an attachment feature extending at least a portion of the longitudinal length and along the first side of the first member to an attachment feature extending at least a portion of the longitudinal length and along a side of the second member.

21. A trough system component, comprising:
a trough member extending a longitudinal length, the trough member configured to form a portion of a carrying surface of a trough system, and the trough member including an attachment feature extending at least a portion of the longitudinal length and along a side of the trough member,
wherein the attachment feature is configured to attach coplanarly to an attachment feature of another member of the trough system.
